(19) United States
(12) Patent Application Publication
(10) Pub. No.: US 2019/0319507 A1
(43) Pub. Date: Oct. 17, 2019

(54) CORELESS MOTOR

(71) Applicant: M-LINK CO., LTD., Yamato-shi, Kanagawa (JP)

(72) Inventors: Manabu SHIRAKI, Yamato-shi (JP); Hidekazu ATARI, Yamato-shi (JP); Atsushi YANBE, Yamato-shi (JP)

(73) Assignee: M-Link Co., Ltd., Yamato-shi, Kanagawa (JP)

(21) Appl. No.: 16/309,299

(22) PCT Filed: Jun. 21, 2017
(86) PCT No.: PCT/JP2017/022915

§ 371 Date: Dec. 12, 2018

(30) Foreign Application Priority Data
Jun. 21, 2016 (JP) 2016-122276
Apr. 3, 2017 (JP) PCT/JP2017/013912

(51) Int. Cl. H02K 3/47; H02K 7/00; H02K 7/102; H02K 7/116; H02K 9/06; H02K 11/21; H02K 11/24; H02K 21/22

(52) U.S. Cl. CPC H02K 3/47; H02K 7/003; H02K 7/102; H02K 7/116; H02K 2207/03; H02K 11/21; H02K 11/24; H02K 21/22; H02K 9/06

(57) ABSTRACT

A coreless motor is provided with: a cylindrical coil that is arranged concentrically with a central shaft serving as the center of rotation, that extends in the direction in which the central shaft extends, and in which the end surface on one side of the cylindrical coil is supported by a stator; a cylindrical inner yoke and a cylindrical outer yoke that have the coil sandwiched therebetween in the radial direction and that form a magnetic circuit therebetween; a rotor that is arranged concentrically with the central shaft and that is supported on the central shaft thereof in the radial direction by the central shaft; and a housing that is cylindrical.

### BACKGROUND

### Technical Field

The present invention relates to a coreless motor. More particularly, it relates to the coreless motor wherein it allows various types of the unit such as the speed reduction gear assembly, the braking assembly and the like to be incorporated therein.

### Description of the Prior Art

Conventionally, there have been various types of the motor in which the units such as the speed reduction gear assembly, the braking assembly and the like may be mounted on the side on which driven objects are attached to the rotating shaft of a motor, that is, on the output side of the rotating shaft or on the side opposite the output side

For example, the patent document 4 discloses a motor in which a planetary roller mechanism is arranged between the power shaft and the rotating element disposed concentrically with the power shaft.

The patent documents 1 through 5 disclose the so-called core-type motors. It is already known that the units such as the speed reduction gear assembly and the like can be incorporated within such core-type motors.

On the contrary, the coreless motor, which is the non-core type motor, in which the units such as the speed reduction gear assembly and the like can be incorporated therein has not yet been proposed.

For the coreless motor, this is due to the situation in which I that it has been difficult to incorporate the units such as the speed reduction gear assembly and the like within the motor because it usually has the small size.

The patent document 6 describes an invention for the coreless motor that had been proposed by the present patent applicant. This coreless motor includes a central shaft acting as the center of rotation and extending on the center in the radial direction and a cylindrical coil that extends in the direction in which the central shaft extends and is arranged concentrically with respect to the central shaft. Furthermore, the coreless motor includes a rotor that is arranged concentrically with the central shaft and includes a cylindrical inner yoke and a cylindrical outer yoke between which the cylindrical coil is sandwiched in the radial direction and between which a magnetic circuit is formed.

The coreless motor described in the patent document 6 has the structure in which the central shaft acting as the center of rotation extends inside the coreless motor. Specifically, the central shaft extends through the cylindrical coil in the direction in which the central shaft extends. The central shaft also extends through the rotor that includes the inner yoke and the outer yoke in the direction in which the central shaft extends.

Because of the structure described above, there has been no invention for the coreless motor that is so structured as to enable the units such as the speed reduction gear assembly and the like to be incorporated in any of the conventional coreless motors and even in the coreless motor described in the patent document 6.

### PRIOR TECHNICAL DOCUMENTS

### Patent Documents

Patent Document 1: WO2006/114881
Patent Document 2: Patent Publication 2008-263742
Patent Document 3: Patent Publication 2009-38844
Patent Document 4: Patent Publication 2003-143805
Patent Document 5: Patent Publication 2010-263761
Patent Document 6 WO2015-162826

### SUMMARY OF THE INVENTION

The present invention has for its principal object the provision of a coreless motor in which units such as the speed reduction gear assembly, the braking assembly and the like are coupled to the end of a rotating shaft within the coreless motor and are thus incorporated within the coreless motor without increasing the length (size) in the direction in which the rotating shaft of the rotating shaft of the coreless motor extends.

According to the present invention, the coreless motor includes a cylindrical coil that is arranged concentrically with the central shaft serving as the center of rotation and which, extends in the direction in which the central shaft extends, a cylindrical inner rotor located inside the cylindrical coil, and a space section (gap section) provided inside the cylindrical inner rotor in the direction in which the central shaft extends, thus allowing the units such as the speed reduction gear assembly, the braking assembly, the rotary encoder, the fan assembly, the torque sensor, the electrical circuit and the like to be disposed in that space section.

More specifically, inside the coreless motor, the central shaft does not extend through the cylindrical coil that extends in the direction in which the central shaft acting as the center of rotation and through the cylindrical inner yoke and thus terminates on the middle way of the inner yoke. This permits the space section (gap section) to be provided in the direction in which the central shaft extends within the coreless motor or specifically in the direction in which the central shaft extends on the inner side of the cylindrical inner yoke, thus allowing the units to be disposed in that space section (gap section).

The following describes the coreless motor having the structures which will be described below.

[1]

A coreless motor which comprises:

a cylindrical coil arranged concentrically with a central shaft acting as the center of rotation, the end surface on one side of said cylindrical coil being supported by a stator and extending in the direction in which the central shaft extends;

a rotor including a cylindrical inner yoke and a cylindrical outer yoke between which said cylindrical coil is sandwiched and between which a magnetic circuit is formed, said rotor being disposed concentrically with said central shaft and being supported by said central shaft on the central side thereof in the radial direction; and a cylindrical housing including a cylindrical section provided outside said cylindrical outer yoke in the radial direction and being provided rotatably with respect to said central shaft, wherein the coreless motor allows a unit coupled to the end of said central shaft within the coreless motor to be disposed in a space section formed within said coreless motor.

[2]

The coreless motor as defined in [1], wherein the side of said central shaft that faces opposite the end to which the units are to be coupled is supported rotatably in two locations spaced away from each other in the direction in which said central shaft extends and on the central side of said housing in the radial direction thereof, thereby allowing said housing to rotate with respect to the central side in the radial direction thereof.

[3]

A coreless motor which comprises:

a cylindrical coil arranged concentrically with a central shaft acting as the center of rotation, the end surface on one side of said cylindrical coil being supported by a stator and extending in the direction in which the central shaft extends;

a rotor including a cylindrical inner yoke and a cylindrical outer yoke between which said cylindrical coil is sandwiched and between which a magnetic circuit is formed, said rotor being disposed concentrically with said central shaft and being supported by said central shaft on the central side thereof in the radial direction; and

a cylindrical housing including a cylindrical section provided outside said cylindrical outer yoke in the radial direction and being provided rotatably with respect to said central shaft and having said cylindrical section that is driven for rotation by the rotation of said central shaft, wherein the coreless motor allows a unit coupled to the end of said central shaft in said coreless motor to be disposed in a space section formed within said coreless motor.

[4]

The coreless motor as defined in [3], wherein said unit is a mechanism that transmits the rotation of said central shaft to said housing.

[5]

The coreless motor as defined in [3] or [4], wherein the side of said central shaft that faces opposite the end to which said unit is to be coupled is supported rotatably in two locations spaced away from each other and on the central side of said stator in the radial direction thereof.

[6]

The coreless motor as defined in any one of [1] through [5], wherein said space section is formed by allowing said central shaft not to extend through said cylindrical coil in the direction in which said central shaft extends and by thus terminating said central shaft on the middle way of said cylindrical coil in the direction in which said central shaft extends

[7]

The coreless motor as defined in any one of [1] through [5], wherein said space section is formed by allowing said central shaft not to extend through said cylindrical inner yoke in the direction in which said central shaft extends and by terminating said central shaft on the middle way of said inner yoke in the direction in which said central shaft extends.

[8]

The coreless motor as defined in any one of [1] through [7], wherein any one of said units has its outer peripheral diameter that is smaller than the inter peripheral diameter of said inner yoke.

[9]

The coreless motor as defined in any one of [1] through [8], wherein said units has a portion on the side facing opposite the side on which said unit is attached to the end of said central shaft and has its outer peripheral diameter that is larger than the inner peripheral diameter of said inner yoke.

### Advantages of the Invention

The coreless motor offered by the present invention eliminates the need of increasing the length (size) in the direction in which the rotating shaft therein, and allows the units such as the speed reduction gear assembly, the braking assembly and the like to be incorporated within the coreless motor by coupling those units to the end of the rotating shaft within the coreless motor.

### BRIEF DESCRIPTION OF DRAWINGS

FIG. 1 is a sectional view illustrating the internal structure of the coreless motor in accordance with one embodiment of the present invention;

FIG. 2 is a sectional view illustrating the internal structure of the coreless motor in accordance with another embodiment of the present invention;

FIG. 3 is a sectional view illustrating the internal structure of the coreless motor in accordance with still another embodiment of the present invention;

FIG. 4 is a sectional view illustrating another internal structure of the coreless motor in accordance with the embodiment shown in FIG. 3;

FIG. 5 is a sectional view illustrating the internal structure of the coreless motor in accordance with further another embodiment of the present invention;

FIG. 6 is a sectional view illustrating another internal structure of the coreless motor in accordance with the embodiment shown in FIG. 5;

FIG. 7 is a sectional view illustrating the internal structure of the coreless motor in accordance with still further another embodiment of the present invention;

FIG. 8 illustrates the concept of the rotation transmitting gear assembly in the embodiment shown in FIG. 7;

FIG. 9 illustrates the concept of the arrangement of the sun gears, planetary gears and carrier that are included in the rotation transmitting section in accordance with the embodiment shown in FIG. 7 in which (a) illustrates the decoupling of the high speed side rotation transmitting section as it is viewed from the lateral side, (b) is a sectional view of the high speed side rotation transmitting section, (c) illustrates the decoupling of the low-sped side rotation transmitting section as it is viewed from the lateral side and (d) is a sectional view illustrating the low speed side rotation transmitting section as it is viewed from the lateral side;

FIG. 10 is a sectional view illustrating the internal structure of the coreless motor in the example in which one of the units arranged in the coreless motor is the one-step speed reduction gear assembly in accordance with the embodiment shown in 7;

FIG. 11 illustrates the concept of the rotation transmitting mechanism in accordance with the embodiment shown in FIG. 10;

FIG. 12 is a sectional view illustrating the example of anther internal structure of the coreless motor in accordance with the embodiment shown in FIG. 7;

FIG. 13 illustrates the concept of the rotation transmitting mechanism in accordance with the embodiment shown in FIG. 12;

FIG. 14 is a sectional view illustrating the internal structure of the coreless motor in the example in which the rotation is transmitted from the speed reduction gear assembly incorporated within the coreless motor to the housing by using the “mechanical paradox planetary gears” mechanism in accordance with the embodiment shown in FIG. 10; and

FIG. 15 illustrates the concept of the rotation transmitting gear assembly in accordance with the embodiment shown in FIG. 14.

### BEST MODE OF EMBODYING THE INVENTION

### Embodiment 1

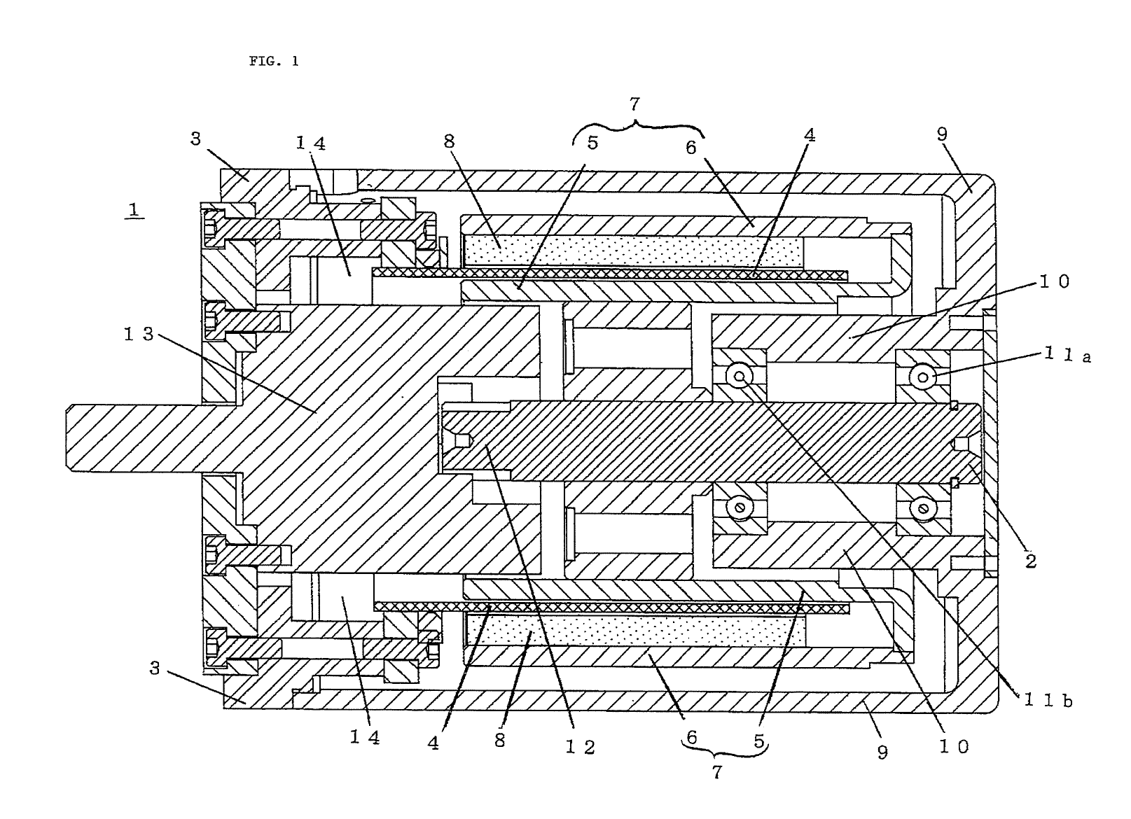

The embodiment shown in FIG. 1 provides one example in which a unit 13 is incorporated within the coreless motor 1. As the unit 13, for example, the mechanism that includes the speed reduction gear assembly as it is known to the prior art may be employed.

The coreless motor 1 shown in FIG. 1 contains the rotating shaft 2, the stator 3, the coil 4, the rotor 7 and the housing 9. The rotating shaft 2 is a central shaft that acts as the center of rotation.

The coil 4 having the cylindrical form extends in the direction in which the rotating shaft 2 extends. The coil 4 is arranged concentrically with the rotating shaft 2, and the end surface on one side of the coil 4 is supported by the stator 3.

The cylindrical coil 4 is the non-core type coil that can be conducted electrically by flowing the electric current therethrough. In the embodiment shown in FIG. 1, it is shown that the cylindrical coil 4 is shaped like the cylindrical form and has the lamination construction made of the electrically conducted metal sheets that is built by superimposing a plurality of wire sections and electrically insulating layers that are spaced away from each other in the longitudinal direction in which the rotating shaft 2 extends. The thickness of coil in its radial direction is less than 5 mm, for example, and the coil has the predetermined rigidity. The cylindrical coil such as the one shown in FIG. 1 may be obtained by the manufacturing method described in the Japan patent No. 3704-44.

The rotor 7 is disposed concentrically with the rotating shaft 2 and is supported fixedly by the rotating shaft 2 on the central side thereof in the radial direction.

The rotor 7 includes a cylindrical inner yoke 5 and a cylindrical outer yoke 6. The cylindrical coil 4 is sandwiched between the cylindrical inner yoke 5 and the cylindrical outer yoke 6 in the radial direction and a magnetic circuit is formed between those yokes 5 and 6.

In the embodiment shown in FIG. 1. a magnet 8 such as a permanent magnet, for example, is disposed on the inner peripheral surface of the outer yoke. 6. In this way, a magnetic field having the doughnut-like cross section is developed between the inner yoke 5 and the outer yoke 6.

The embodiment shown in FIG. 1 may be replaced by another embodiment in which the magnet 8 may be disposed on the outer peripheral surface of the inner yoke 5.

As shown in FIG. 1, the housing 9 shaped like the cylindrical form has a cylindrical portion that is disposed outside the outer yoke 6 in the radial direction. In the embodiment shown, one side (left side in FIG. 1) of the housing 9 on which the cylindrical section is open is fixed to the stator 3.

The housing 9 supports the rotating shaft 2 on its center in the radial direction so that it can cause the rotating shaft 2 to rotate. In the embodiment shown in FIG. 1, the housing 9 includes a round plate section that is provided on the side opposite the one side on which the housing 9 is fixed to the stator 3, that is, on the other side (right side in FIG. 1). The housing 9 further includes a tubular section 10 that is provided on the center of the round plate section in the radial direction. The tubular section 10 extends toward the stator 3 in the direction in which the rotating shaft 2 extends. The rotating shaft 2 is thus supported by the housing 9 so that it can be rotated through bearing assemblies 11a, 11b that are provided on each respective end side in the direction in which the rotating shaft 2 including the tubular section 10 extends.

The housing 9 is thus structured such that it can rotate with respect to the rotating shaft 2.

As described above and as shown in FIG. 1, the rotating shaft 2 is supported rotatably in the two locations spaced away from each other in the direction in which the rotating shaft 3 extends and on the central side of the housing 9 in its radial direction. This assures that the rotating shaft 2 can rotate reliably and stably.

It may be apparent from the above description that the magnetic field having the doughnut-like cross section is developed between the inner yoke 5 and the outer yoke 6, which causes the rotor 7 and the rotating shaft 2 supporting the rotor 7 to be rotated by supplying a predetermined electric current through the coil 4.

In this embodiment, the rotating shaft 2 does not extend through the cylindrical coil 4 in the direction in which the rotating shaft 2 extends. Thus, the rotating shaft 2 terminates on the middle way of the coil 4 in the direction in which the rotating shaft 2 extends. This creates a space section 14 within the coreless motor 1.

In the space section 14 within the coreless motor 1, the unit 13 is coupled to the end 12 of the rotating shaft 2 within the coreless motor 1. In this way, the unit 13 is disposed in the space section 14 within the coreless motor 1.

More specifically, the coreless motor 1 is structured such that the unit 13 to be coupled to the end 12 of the rotating shaft 2 can be disposed in the space section 14 within the coreless motor 1.

In the embodiment shown in FIG. 1, the unit 13 may be any of the conventional speed reduction gear assemblies.

In the prior art coreless motor in which the speed reduction gear assembly was connected to the rotating shaft within the coreless motor, the speed reduction gear assembly was connected outside the coreless motor 1 in the direction in which the rotating shaft extended. Thus. the length of the rotating shaft within the coreless motor is greater by the length of any of the speed reduction gear assemblies that will be mounted within the coreless motor.

In the embodiment shown in FIG. 1, the rotating shaft 2 does not extend through the cylindrical coil 4 in the direction in which the rotating shaft 2 extends. Thus, the rotating shaft 2 terminates on the middle way of the coil 4 in the direction in which the rotating shaft 2 extends. As described above, this creates the space section 14 inside the cylindrical coil 4 within the coreless motor 1.

The space section 14 is provided to allow the unit 13 to be coupled to the end 12 of the rotating shaft 2 by disposing the unit 13 in this space section that is created inside the cylindrical coil 4 within the coreless motor 1.

The speed reduction gear assembly can thus be connected to the rotating shaft within the coreless motor without increasing the length of the rotating shaft in the longitudinal direction thereof.

In this embodiment shown in FIG. 1, the unit 13 has its outer peripheral diameter that is smaller than the inner peripheral diameter of the inner yoke 5.

In this embodiment and specifically, a space section is created inside the inner yoke 5, and the units 13 such as the speed reduction gear assembly can be connected to the end 12 of the rotating shaft 2 within the coreless motor 1 by disposing the unit 13 in this space section.

This permits the speed reduction gear assembly to be connected to the rotating shaft 2 within the coreless motor 1 without increasing the length in the direction in which the rotating shaft 2 extends within the coreless motor.

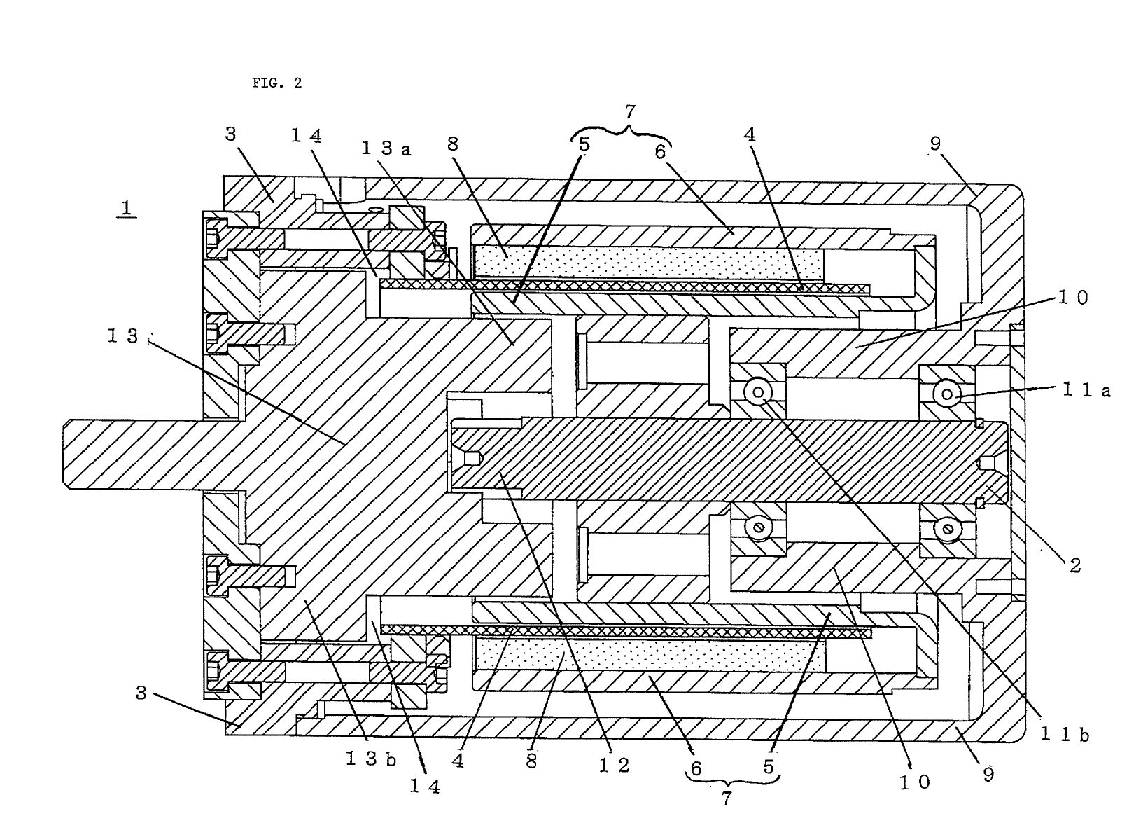

The embodiment in FIG. 2, which is the variation of the embodiment shown 1, represents the embodiment in which the unit 13 includes a part 13b whose outer peripheral diameter is greater than the inner peripheral diameter of the inner yoke 5.

That part 13a of the unit 13 which will be connected to the end 12 of the rotating shaft 2 has its outer peripheral diameter that is smaller than the inner peripheral diameter of the inner yoke 5 whereas the part of the units 13 as indicted by 13b has its outer peripheral diameter which is greater than the inner peripheral diameter of the inner yoke 5.

In other words and at least, that part 13a of the unit 13 which will be connected to the end 12 of the rotating shaft 2 has its outer peripheral diameter which is smaller than the inner peripheral diameter of the inner yoke 5, and that part 13b which will be connected to the end 12 of the rotating shaft 2 has its outer peripheral diameter which is greater than the inner peripheral diameter of the inner yoke 5.

In the embodiment shown in FIG. 2, the coreless motor is also structured such that the unit 13 which will be coupled to the end 12 of the rotating shaft 2 within the coreless motor 1 can be disposed in this space section 14.

This permits the speed reduction gear assembly to be connected to the rotating shaft 2 within the coreless motor 1 without increasing the length in the direction in which the rotating shaft 2 extends. In this point, the embodiment 2 is the same as the embodiment in FIG. 1.

The other points in the embodiment in FIG. 2 are the same as those in the embodiment in FIG. 1 which has been described above. The embodiment in FIG. 2 will not be described below except those parts which are similar to those in the embodiment in FIG. 1. Those parts or elements that are similar to those in the structures described above are indicated by the corresponding reference numerals.

### Embodiment 2

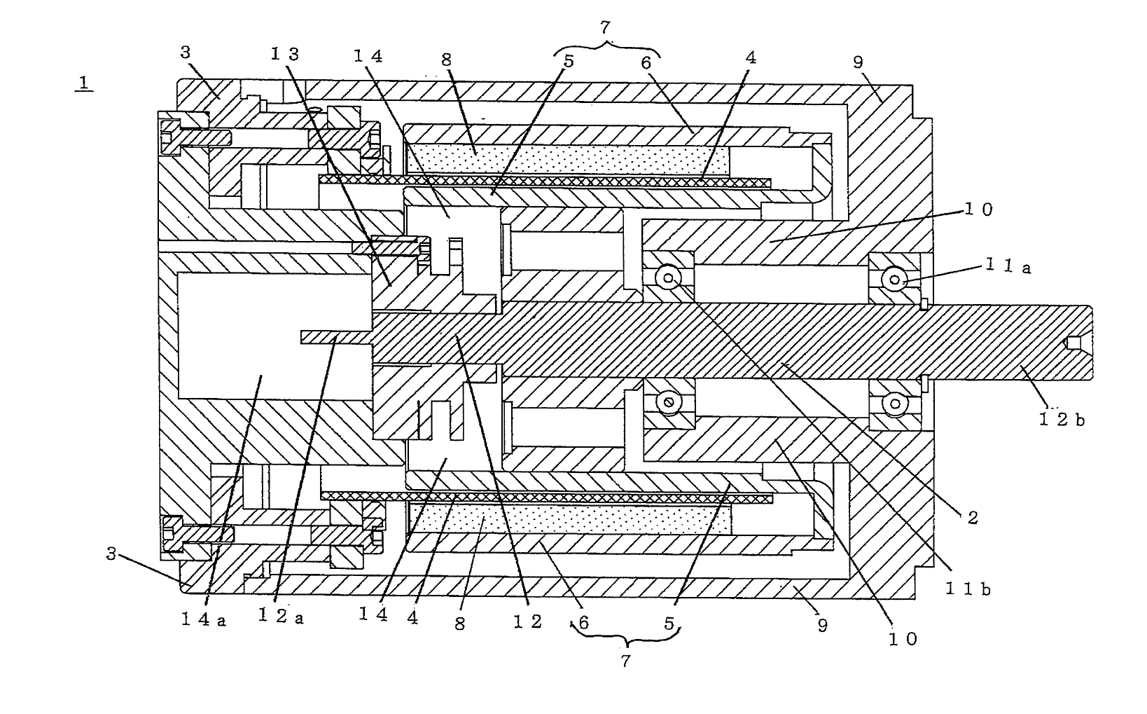

The embodiment shown in FIG. 3 provides another example in which the units 13 are incorporated within the coreless motor. In this embodiment, a braking assembly is employed as one of the units 13.

In the embodiment shown in FIG. 3, the rotating shaft 2 supported rotatably by the housing 9 provides output at the end 12b of the rotating shaft 2 by extending up to the outside of the housing 9. In other respects, the structure in this embodiment is the same as the structure described in the preceding embodiment 1. Those parts of the structure in the embodiment 2 which are similar to the parts in the preceding embodiment 1 are given corresponding reference numerals. Thus, those similar parts will not be described below to avoid the duplication.

In the embodiment shown in FIG. 3, the rotating shaft 2 does not extend through the cylindrical inner yoke 5 in the direction in which the rotating shaft 2 extends and terminates on the middle way of the inner yoke 5 in the direction in which the rotating shaft 2 extends. This allows a space section 14 to be created inside the cylindrical inner yoke 5 within the coreless motor 1.

In the embodiment 2, one of the units 13 may be a braking assembly that can be connected to the end 12 of the rotating shaft 2 in the coreless motor 1.

The embodiment 2 is provided such that the whole braking assembly 13 can be disposed inside the inner yoke 5

Any of the other units than the braking assembly may be connected to the forward end or output end 12a of the rotating shaft 2 that extends into the space section 14a within the coreless motor 1.

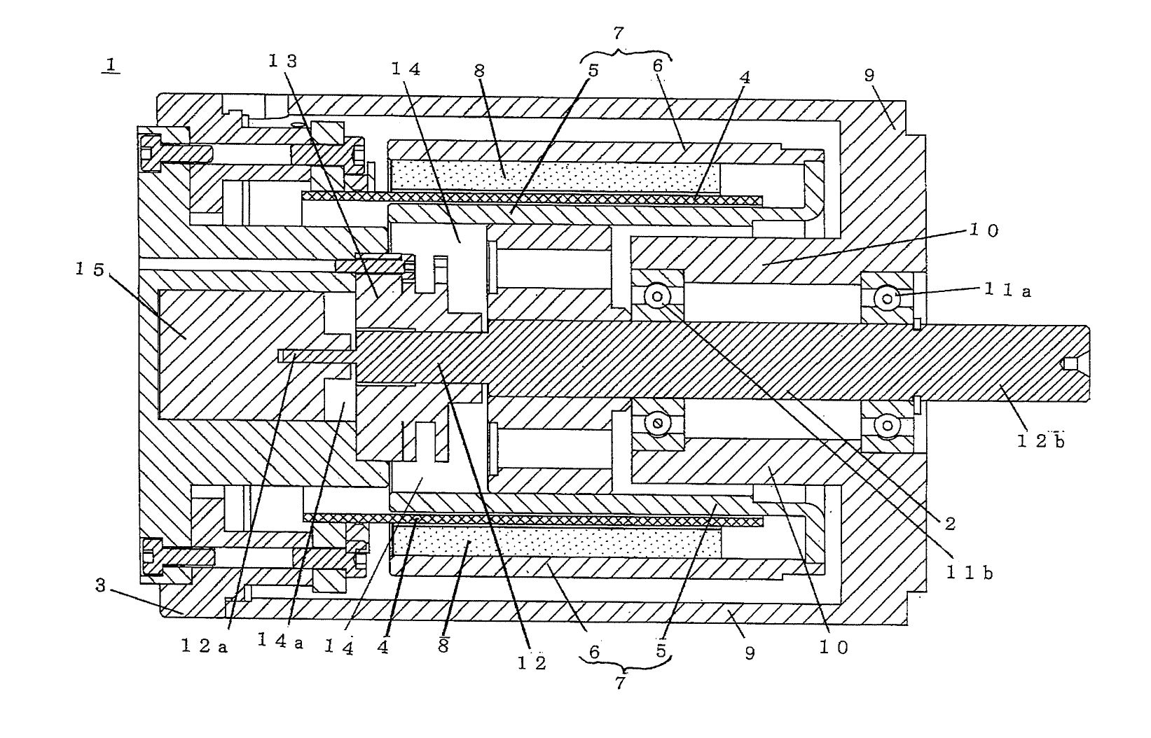

The embodiment shown in FIG. 4 represents one example of the embodiment in FIG. 3 in which a particular unit 15 is connected to the forward end 12a of the rotating shaft 2 that extends into the space section 14a that is equivalent to the space section 14 within the coreless motor 1.

As one example of the particular unit 15, the rotary encoder may be connected.

The embodiment in FIG. 4 allows several units such as the unit 13 and the unit 15 to be incorporated within the coreless motor 1.

In the embodiment in FIG. 4, the unit 13 and the unit 15 have their respective outer peripheral diameters which are smaller than the inner peripheral diameter of the inner yoke 5.

Like the preceding embodiments, this embodiment allows a space section to be created inside the inner yoke 5. Inside this spaced section, the unit 13 and the unit 15 can be coupled to the respective ends 12, 12a of the rotating shaft 2.

### Embodiment 3

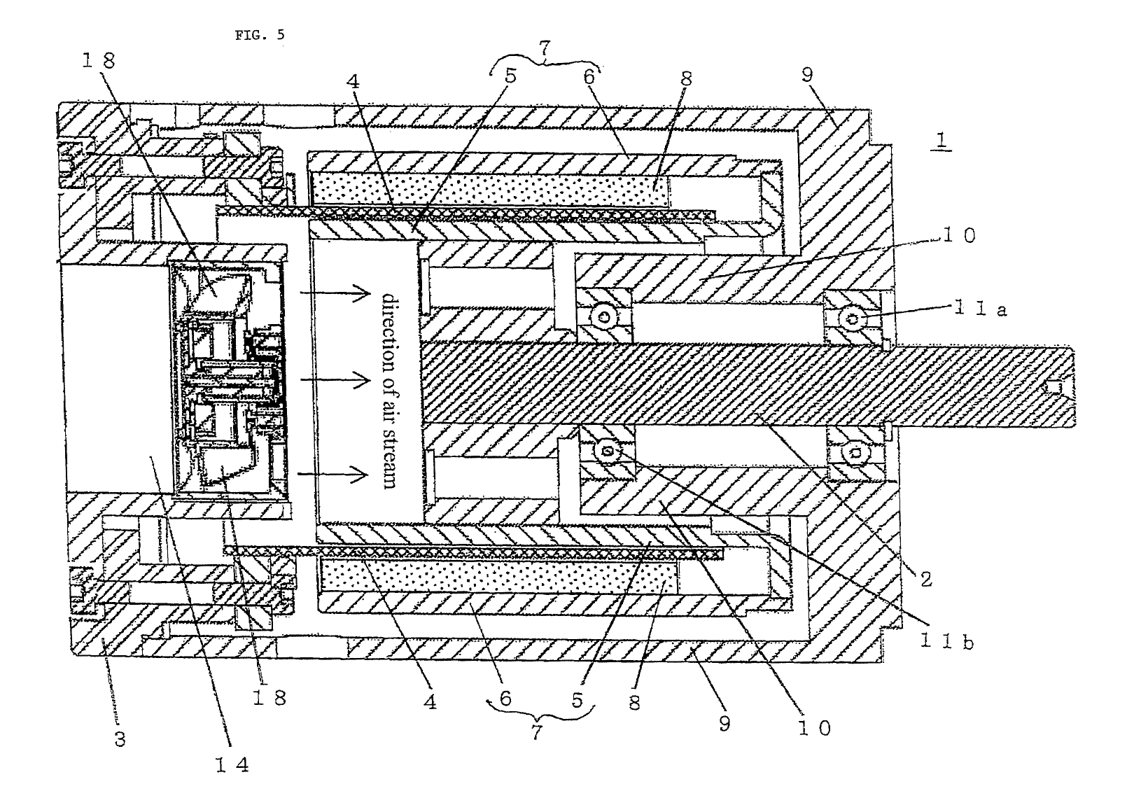

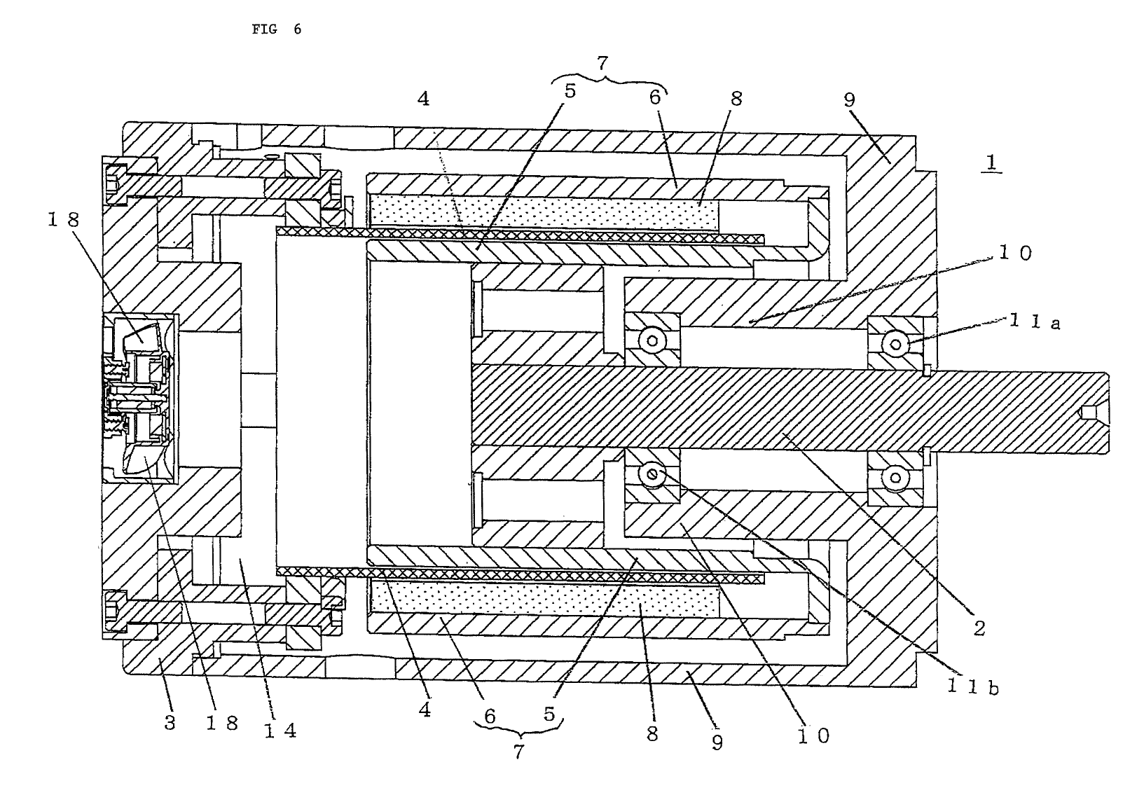

The embodiments shown in FIG. 5 and FIG. 6 provide another example in which the units are incorporated within the coreless motor 1. As one of the units, a fan assembly may be employed.

Like the embodiments shown in FIG. 3 and FIG. 4, it shown in the embodiments shown in FIG. 5 and FIG. 6 that the rotating shaft 2 does not extend through the inner yoke 5 in the direction in which the rotating shaft 2 extends and terminates on the middle way of the inner yoke 5 in the direction in which the rotating shaft 2 extends. This allows a space section to be created inside the cylindrical inner yoke 5.

It is shown in the embodiment in FIG. 5 that inside the cylindrical inner yoke 5 located inside the cylindrical coil 4 disposed concentrically with the rotating shaft 2, the space section (gap section) 14 is provided in the direction in which the rotating shaft 2 extends. The fan assembly 18 is disposed in this space section 14.

The embodiment shown in FIG. 6 is provided so that it allows the fan assembly 18 to be disposed outside the end edge of the inner yoke 5 in the direction in which the rotating shaft 2 extends. Like the embodiment in FIG. 5, the fan assembly 18 has its outer peripheral diameter which is smaller than the inner peripheral diameter of the inner yoke 5.

Those other parts in the embodiment in FIG. 6 which are the same as the parts that have been described in the embodiment 1 by using FIG. 1 will not be described to avoid the duplication. Thus, those other parts are given corresponding reference numerals.

A magnetic field having the doughnut-like cross section is developed between the inner yoke 5 and the outer yoke 6, which causes the rotor 7 and the rotating shaft 2 supporting the rotor 7 to be rotated by supplying a predetermined electric current through the coil 4.

In the embodiment shown in FIG. 5, the fan assembly 18 is disposed in the space section (gap section) 14 that is created inside the inner yoke 5 in the direction in which the rotating shaft 2 extends. As the rotating shaft 2 and the rotor 7 (the inner yoke 5 and the outer yokes 6 included in the rotor) are rotating, this causes the fan assembly 18 to produce an air stream that flows toward the interior of the coreless motor 1.

Although this is not shown in FIGS. 5 and 6, the fan assembly 18 may be operated by supplying the power to the fan assembly 18 through the power line that is provided for supplying the power to the fan assembly 18.

The interior of the coreless motor can be cooled by the air stream flow thus produced by the fan assembly 18.

### Embodiment 4

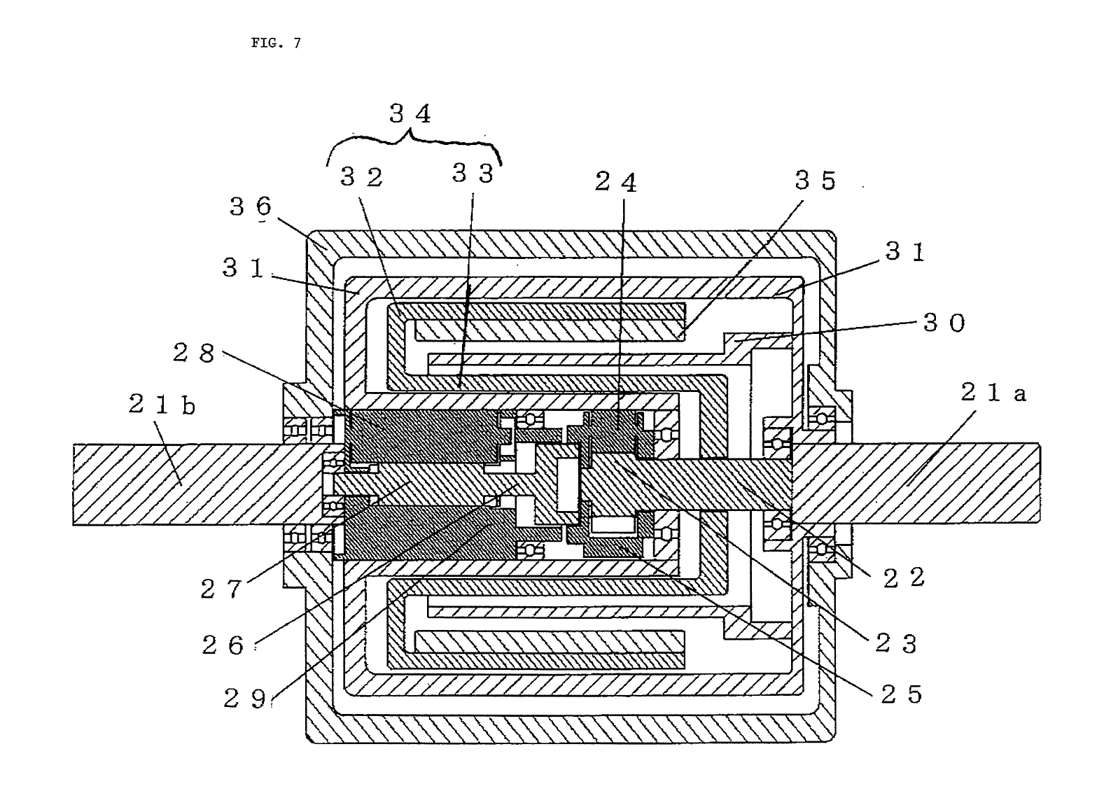

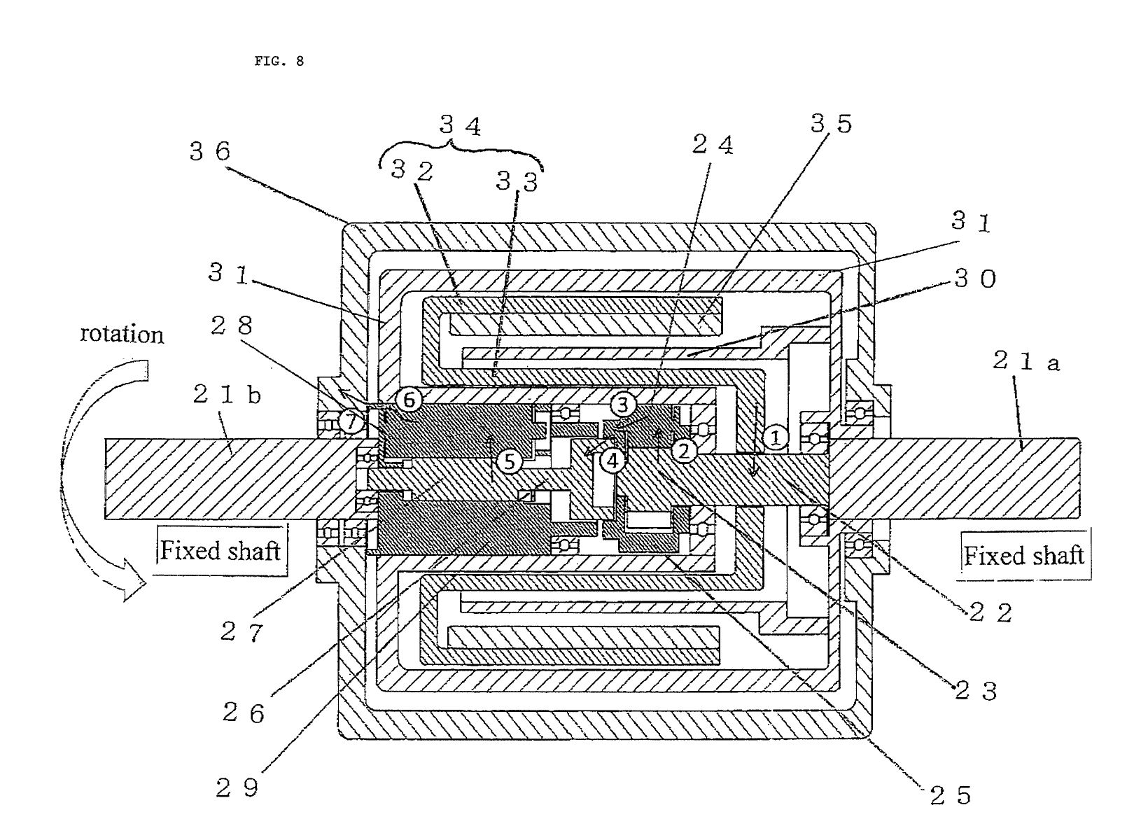

The following describes another embodiment of the present invention by referring to FIG. 7 and FIG. 8.

In the embodiment shown in FIGS. 7 and 8, the rotating shaft 22 within the coreless motor 1 is provided such that it extends between the fixed shafts 21a and 21b in the direction in which those fixed shafts 21a and 21b extend. The cylindrical housing 36 is supported so that it can rotate with respect to the fixed shafts 21a and 21b. The cylindrical housing 36 is then caused to rotate in the circumferential direction of the fixed shafts 21a and 21b as the rotating shaft 22 rotates.

Like all of the preceding embodiments, the rotating shaft 22 in the current embodiment is also the central shaft acting as the center of rotation

The unit that is incorporated inside the coreless motor 1 has the form of the mechanism for transmitting the rotation of the rotating shaft 22 to the housing 36. As the rotating shaft rotates, this mechanism causes the cylindrical housing 36 to rotate in the circumferential direction of the fixed shafts 21a and 21b as the rotating shaft rotates.

The unit that is incorporated inside the coreless motor and has the form of the rotation transmitting mechanism may be implemented by the speed reduction gear assembly, for example.

The coreless motor shown in FIG. 7 also includes the rotating shaft 22, the stator 31, the cylindrical coil 30, the rotor 34 and the cylindrical housing 36.

The cylindrical coil 30 extends in the direction in which the rotating shaft 22 extends and is disposed concentrically with the rotating shaft 22, and the end surface of the coil 30 on one side thereof is supported by the stator 31. In the embodiment in FIG. 7, the end surface on the right side is supported by the stator 31.

The stator 31 has the cylindrical form and has its radial inner side located on the right side in FIG. 7 and fixed to the fixed shaft 21a.

The cylindrical stator 31 includes an outer side tubular section located outside the outer yoke 32 included in the rotor 34 in the radial direction, a round plate section turned on the left side of the outer side cylindrical section in FIG. 7 and extending toward the radial inner side and an inner side cylindrical section turned on the internal diameter end of the round plate section and extending toward the right side in FIG. 7.

The cylindrical coil 30 is made of non-core coil that can be electrically conducted as described in connection with the embodiment 1.

The rotor 34 is disposed concentrically with the rotating shaft 22 and is supported fixedly by the rotating shaft 22 on the central side thereof in the radial direction. In the embodiment shown, the rotor 34 has its radial inner side fixed to the rotating shaft 22 on the right side of the rotor 34.

Like the embodiment 1, the rotor 34 includes a cylindrical inner yoke 33 and a cylindrical outer yoke 32. A cylindrical coil 30 is sandwiched in the radial direction between the cylindrical inner yoke 33 and the cylindrical outer yoke 32 and a magnetic circuit is created between those yokes.

In the embodiment shown in FIG. 7, the rotor 34 further includes a magnet made of a permanent magnet or the like that is disposed on the inner peripheral surface of the outer yoke 32. This permits a magnet field having the doughnut-like cross section to be developed between the inner yoke 33 and the outer yoke 32.

Like the embodiment 1, the embodiment shown in FIG. 7 can be replaced by another embodiment in which the magnet 35 may be disposed on the outer peripheral surface of the inner yoke 33.

The housing 36 has the cylindrical form and includes a cylindrical section that is located outside the outer yoke 32 in the radial direction as shown in FIG. 7. In the embodiment in FIG. 7, the cylindrical section located outside the outer yoke 32 of the housing 36 is so structured as to cover the outer side cylindrical section of the stator 31 from its radial outer side.

The cylindrical section of the housing 36 includes a right-side round plate portion and a left-side round plate portion on both the ends thereof, each of which extends inwardly in the radial direction. The internal diameter sides of the right- and left-side round plate portions are supported rotatably with respect to the respective fixed shafts 21a and 21b.

In the embodiment in FIG. 7, it is shown that on the right side of the housing 30, the radial inner side of the right-side round plate portion is mounted rotatably on the right end side outer peripheral surface of the stator 31 fixed to the fixed shaft 21a through the corresponding bearing assembly. It is also shown that on the left side of the housing 26, the radial inner side of the left-side round plate portion is mounted rotatably to the fixed shaft 21 through the corresponding bearing assembly.

The radial inner side portion on the right side end of the stator 31 fixed to the fixed shaft 21a includes a tubular portion that extends toward the inside (left side in FIG. 7) of the coreless motor. This tubular portion is provided for supporting the end portion of the rotating shaft 22 located on the side of the fixed shaft 21a so that it can rotate through the corresponding bearing assembly.

In the direction in which the rotating shaft 22 extends and on the left side in FIG. 7 of the location in which the radial inner side of the rotor 34 is fixed to the rotating shaft 22, the rotating shaft 22 is supported rotatably by the inner diameter side of the inner side cylindrical portion of the stator 31 through the corresponding bearing assembly.

In the two locations spaced from each other in the direction in which the rotating shaft 22 extends and between which the radial inner side of the rotor 34 is sandwiched, the rotating shaft 22 is supported rotatably on the radial central side of the stator 22 in the same manner as described. This assures that the rotating shaft 22 cab rotate with stability., which will be described later.

Like the preceding embodiments 1 through 3, a magnetic circuit having the doughnut-like cross section is created between the inner yoke 33 and the outer yoke 32. Thus, the rotor 34 and the rotating shaft 22 supporting the rotor 34 can be rotated by supplying the predetermined electric current through the coil 30.

In this embodiment, the rotating shaft 22 does not extend through the cylindrical coil 30 and the inner yoke 33. Thus, the rotating shaft 22 terminates on the middle way of the coil 30 and inner yoke 33 in the direction in which the rotating shaft 22 extends.

This creates a space section inside the cylindrical coil 30 and the inner yoke 33. The unit to be coupled to the rotating shaft 22 may be disposed in this space section.

In the embodiment in FIGS. 7 and 8, the unit which will be disposed in the space section formed inside the cylindrical coil 30 and the inner yoke 33 and will thus be coupled to the rotating shaft 22 may be implemented by the mechanism for transmitting the rotation of the rotating shaft 22 to the housing 36.

In the embodiment in FIGS. 7 and 8, the unit may be the two-step speed reduction gear assembly for transmitting the rotation of the rotating shaft 22 to the housing 36.

By transmitting the rotation of the rotating shaft 22 to the housing 36 through the speed reduction gear assembly, the housing 36 can be rotated in the circumferential direction of the fixed shafts 21a and 21b extending in the direction in which the rotating shaft 22 extends.

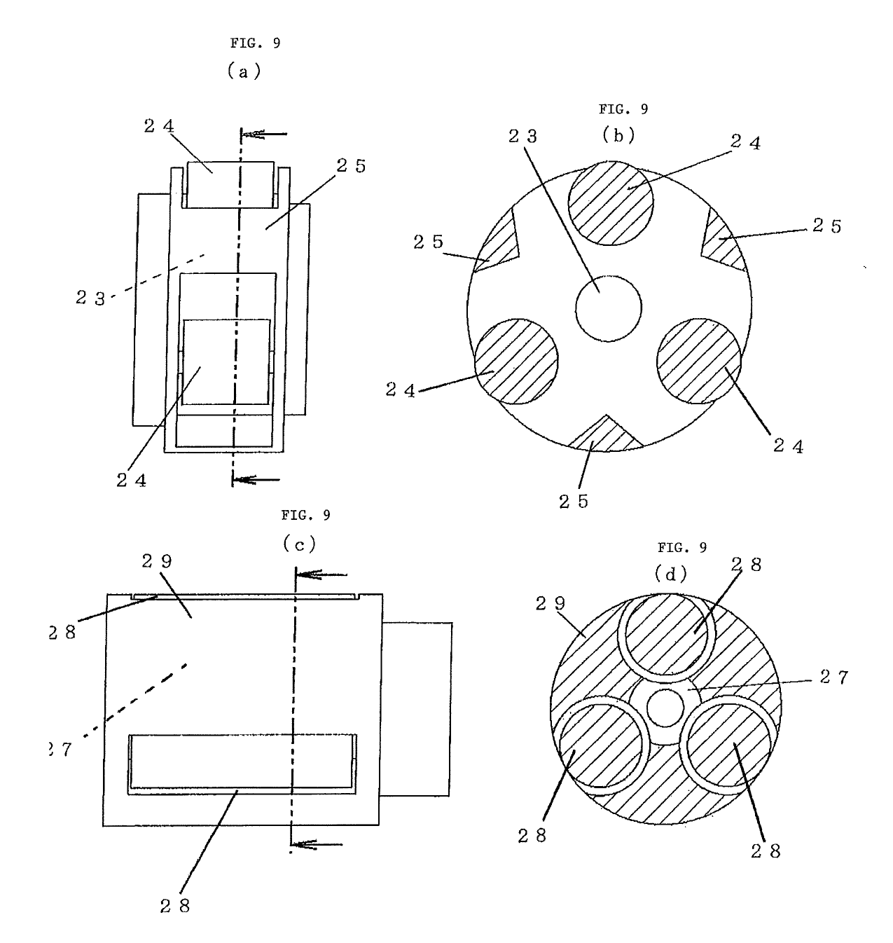

FIG. 9 shows one example of the arrangement in which the sun gear, the planetary gear and the carrier are arranged in accordance with the embodiment in FIGS. 7 and 8.

In FIGS. 7 through 9, it should be noted that the internal gears and the like formed on the inner peripheral surface of the inside tubular portion of the stator 31 are not shown and that the sun gear, the planetary gear, the carrier and the like are schematically shown to illustrate how they are arranged and coupled.

In the embodiment in FIGS. 7 and 8, it is shown in FIG. 7 that the outer peripheral surface on the left end side of the rotating shaft 22 acts as the high speed side san gear 23. Thus, the rotation of the high speed side sun gear 23 is transmitted to the low speed side input shaft 26 through the high speed side planetary gear 14 and the high speed side carrier 25. It is also shown in FIG. 7 that the outer peripheral surface on the left end side of the low speed side input shaft 26 acts as the low speed side sun gear 27. Thus, the rotation of the low speed side sun gear 27 is finally transmitted to the housing 36 through the low speed side planetary gear 28 and the low speed side carrier 29 and further through the carrier disposed between the low speed side carrier 29 and the radial inner side end of the left side round plate portion of the housing 36.

More specifically and as shown in FIG. 8, the rotation is transmitted to the housing in the sequence of (1) from the rotor 34 to the rotating shaft 22, (2) from the high speed side carrier formed on the left end side of the rotating shaft 22 to the high speed side planetary gear, (3) from the high speed side planetary gear to the high speed side carrier, (4) from the high speed side carrier to the low speed side input shaft, (5) from the low speed side sun gear formed on the left end side of the low speed side input shaft to the low speed side planetary gear, (6) from the low speed side gear to the low speed side carrier, and (7) from the low speed side carrier to the carrier arranged between the low speed side low speed side carrier and the housing. In the above sequence, the rotation is finally transmitter to the housing through the carrier mentioned in (7).

In the embodiment shown in FIGS. 7 through 9, the rotation of the rotor 34 and accordingly the rotating shaft 22 was transmitted to the housing 36 by reducing the speed of the rotation by two steps.

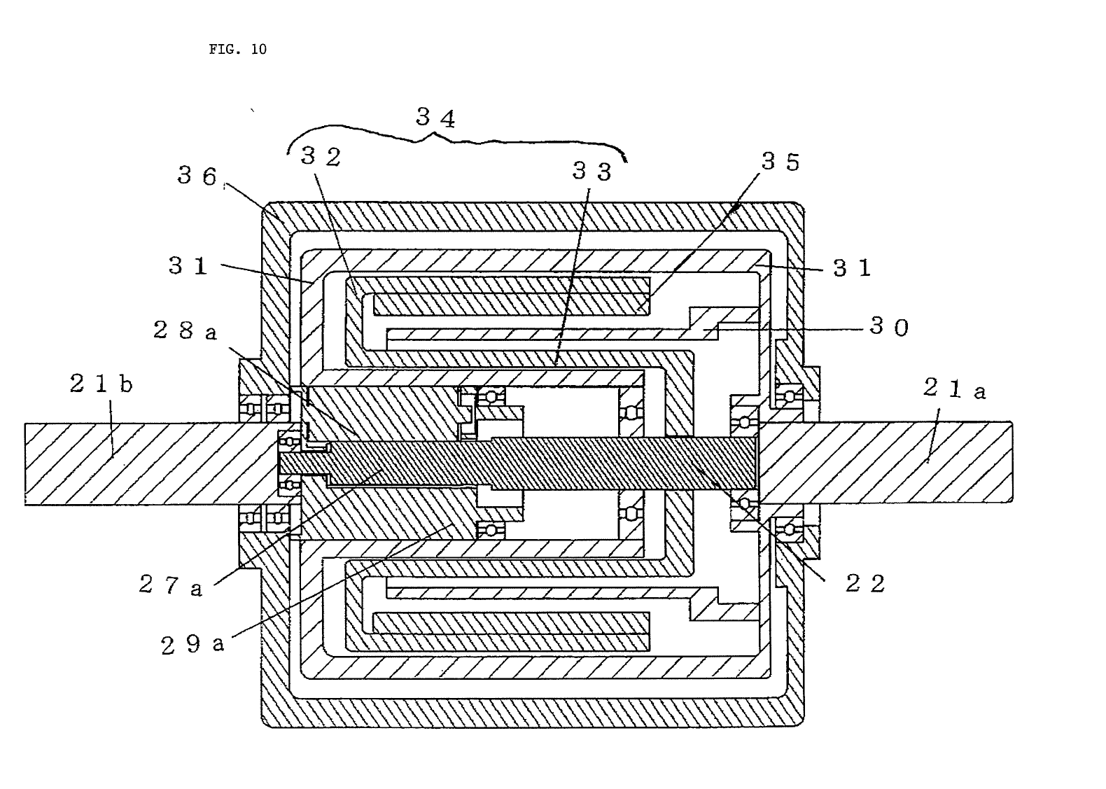

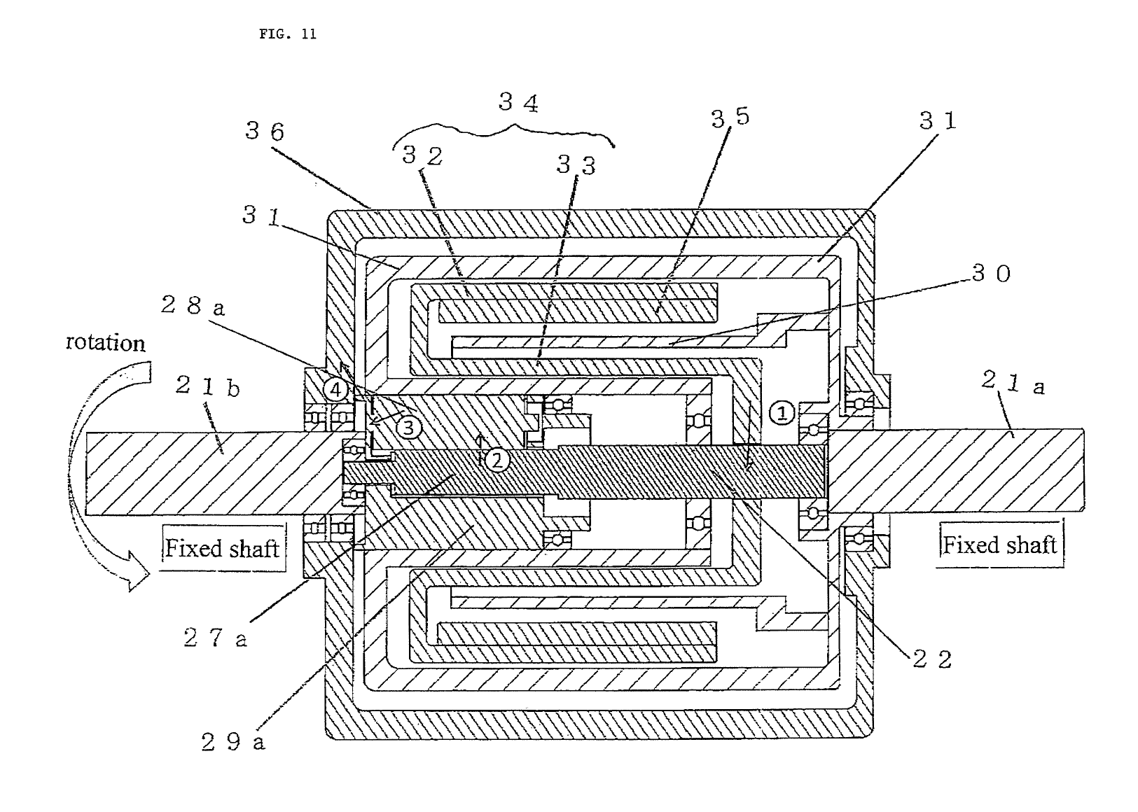

The embodiment in FIGS. 10 and 11 represents one example in which the rotation of the carrier and accordingly the rotating shaft 22 is transmitted to the housing 36 by reducing the speed of the rotation by one step.

It is shown in FIG. 10 that the outer peripheral surface on the left end side of the rotating shaft 22 acts as the sun gear 27a. Thus, the rotation of the sun gear 27a is transmitted to the housing 36 through the planetary gear 28a and the carrier 29a and further through the carrier disposed between the carrier 29a and the radial inside end of the left side round plate portion of the housing 36.

More specifically and as shown in FIG. 11, the rotation is transmitted to the housing in the sequence of (1) from the rotor 34 to the rotating shaft 22, (2) from the sun gear formed to the left end side of the rotating shaft 22 to the planetary gear, (3) from the planetary gear to the carrier, and finally (4) from the carrier to the carrier disposed between that carrier and the housing In the above sequence, the rotation is finally transmitter to the housing through the carrier mentioned in (4).

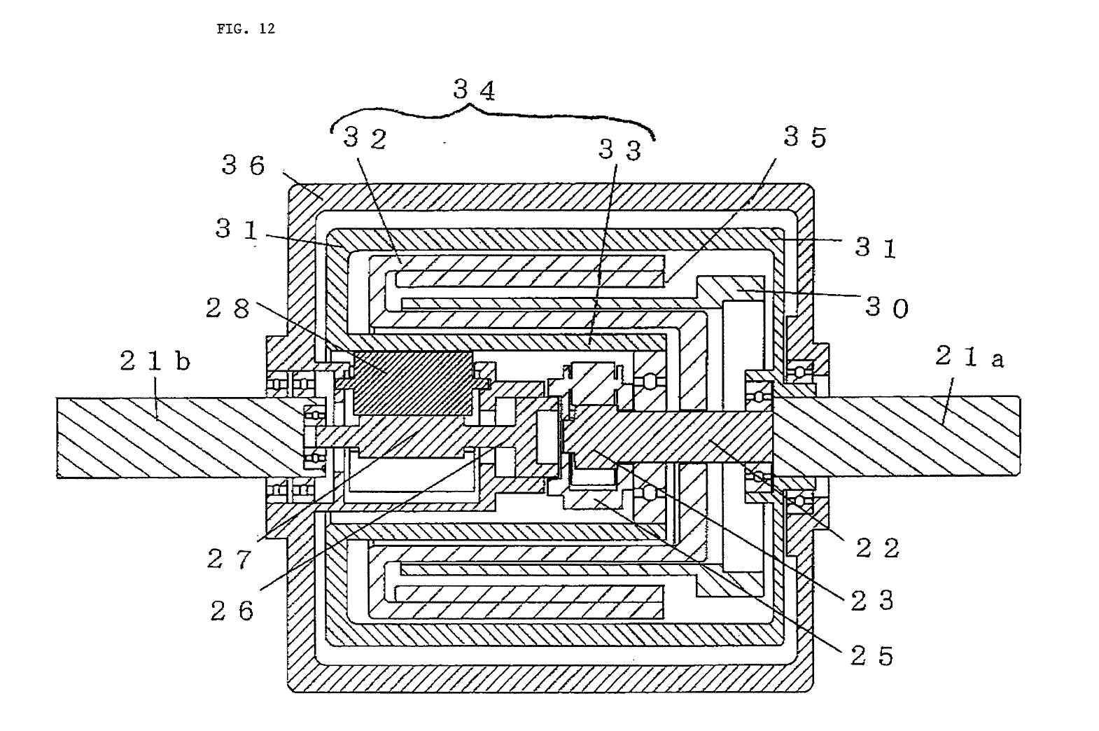

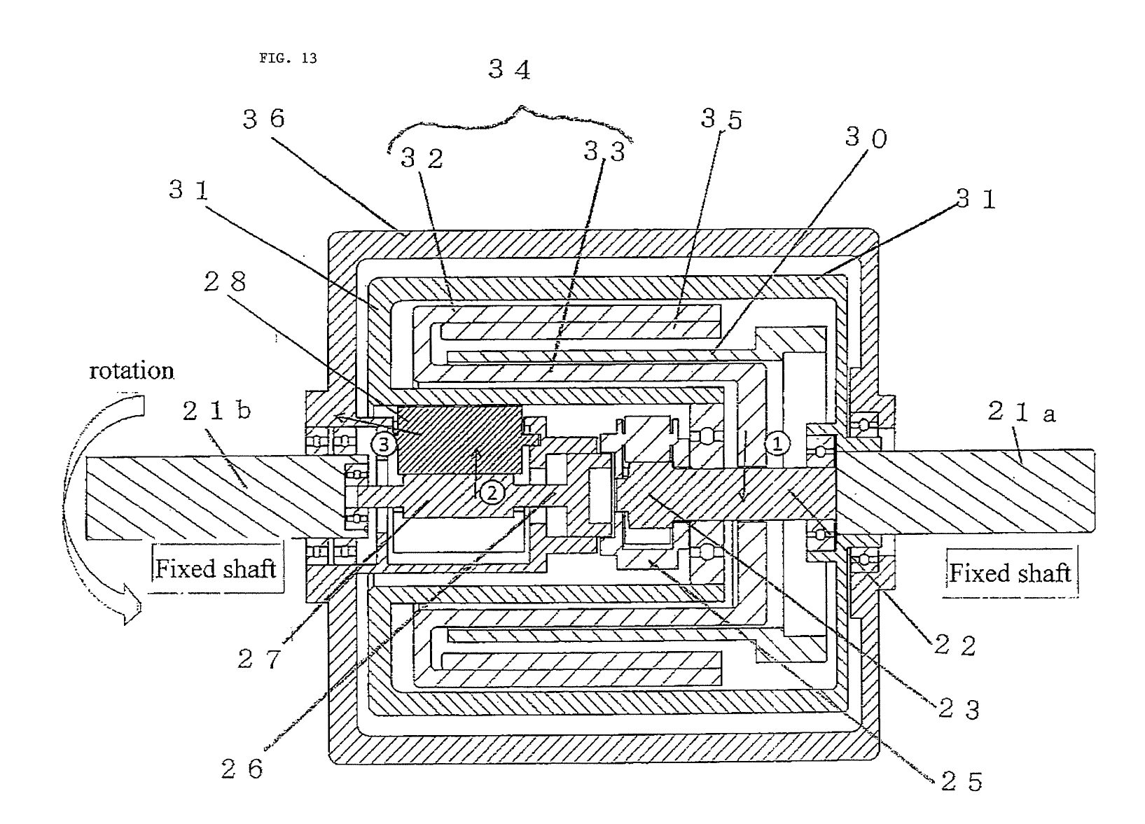

The embodiment in FIGS. 12 and 13 provides the structure in which low speed side carrier that is driven by the revolving movement of the low speed side planetary gear is directly connected (coupled) to the radial inner side end of the left side round plate portion of the housing 36 in accordance with the embodiment in FIGS. 7 and 8.

As shown in FIG. 13, the rotation is transmitted to the housing in the sequence of (1) from the rotor 34 to the rotating shaft 22, (2) from the sun gear formed on the left end side of the low speed side input shaft to the low speed side planetary gear and (3) from the low speed side planetary gear to the low speed side carrier. In the above sequence, the rotation is finally transmitted to the housing through the low speed side carrier connected (coupled) to the housing.

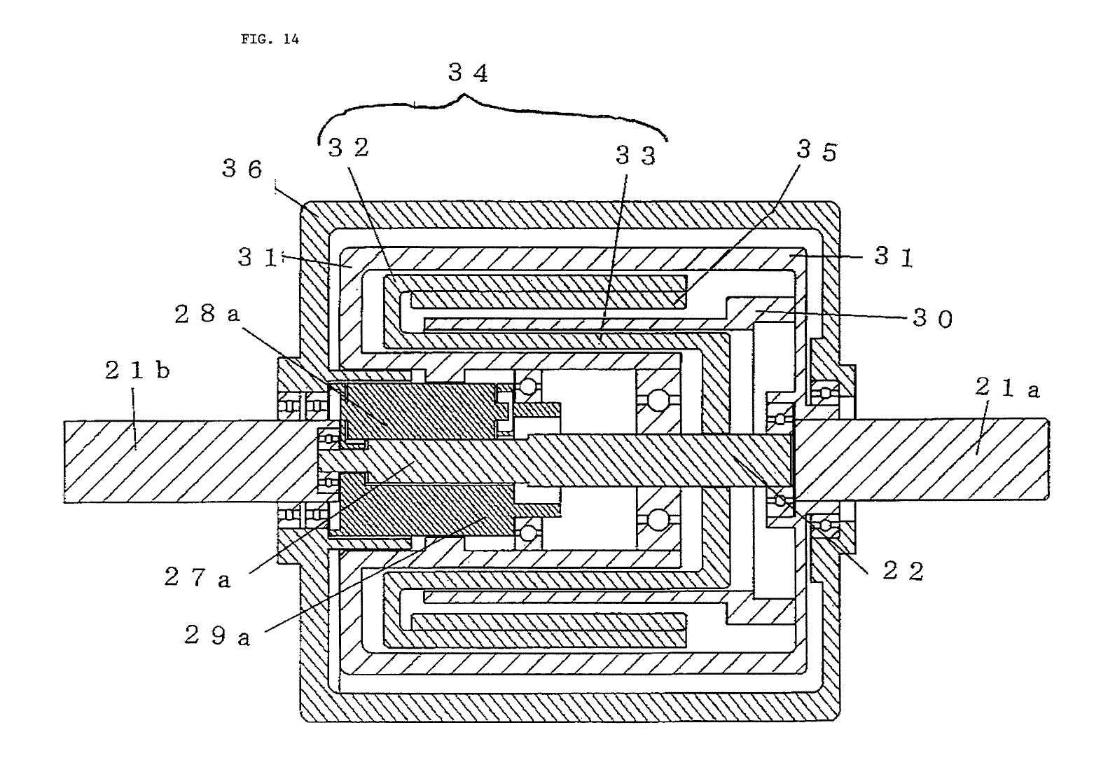

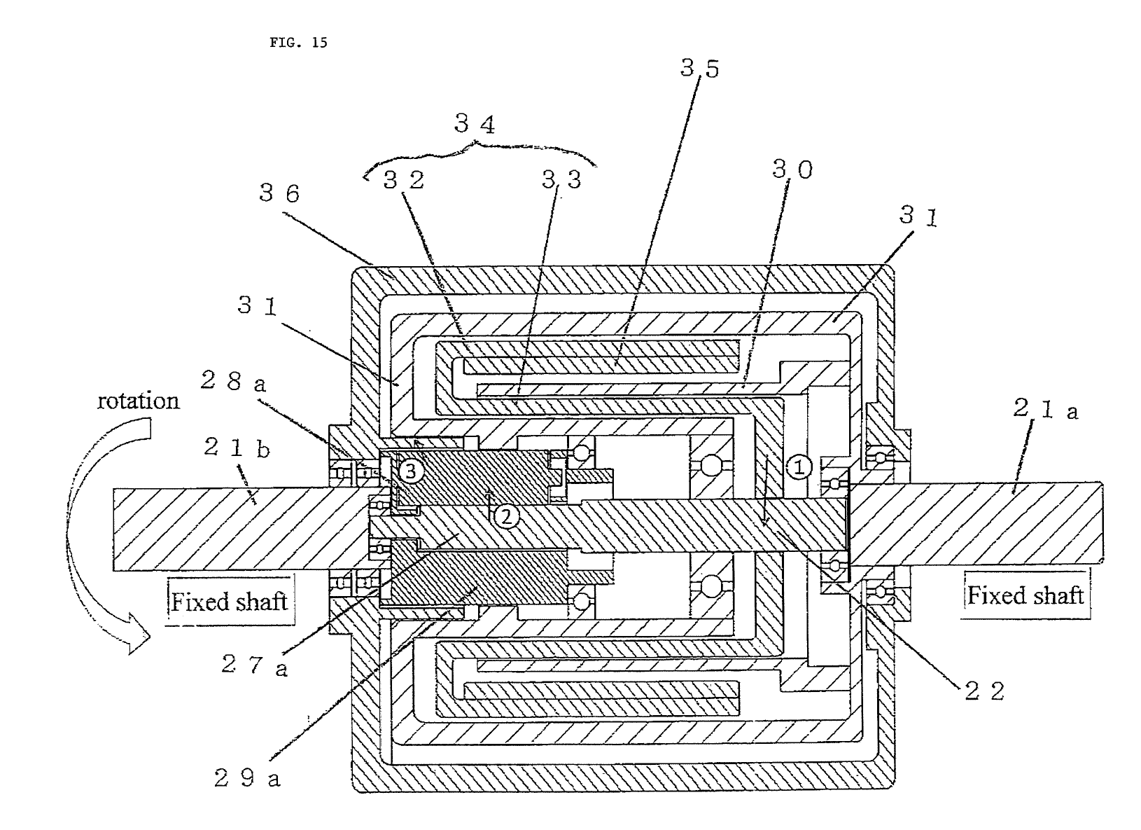

In the embodiment in FIGS. 14 and 15, the mechanism for transmitting the rotation of the rotating shaft 22 through the speed reduction gear assembly coupled to the rotating shaft 22 within the coreless motor in accordance with the embodiment in FIGS. 10 and 11 is implemented by the mechanism that is generally called as the “mechanical paradox planetary gear”.

A tubular section that extends toward the right side in FIG. 14 is formed on the radial inner side end of the left-side round plate portion of the housing 36. An internal gear is mounted rotatably to the inner peripheral wall of this tubular section. Another internal gear is mounded fixedly to the inner peripheral side of the inner side cylindrical portion of the stator 31.

The planetary gear 28a engages the another internal gear mounted fixedly to the inner peripheral side of the inner side cylindrical portion of the stator 31 and the internal gear mounted rotatably to the inner peripheral wall of the above mentioned tubular section of the housing 36.

As shown in FIG. 15, the rotation is transmitted to the cylindrical portion of the housing 36 in the sequence of (1) from the rotor 34 to the rotating shaft 22, (2) from the sun gear formed on the left end side of the rotating shaft 22 to the planetary gear and (3) from the planetary gear to the cylindrical portion of the housing 36.

In accordance with the structure described above, the housing 36 will be rotating more slowly and more mildly than the housing 36 in the embodiment shown in FIGS. 10 and 11 even if the rotating shaft 22 is rotating with the same speed as the rotating shaft in the embodiment in FIGS. 10 and 11.

Although the present invention has been described above with reference to several specific embodiments thereof shown in the accompanying drawings, it should be understood that the preset invention is not limited to those embodiments and may be modified in several ways without departing from the scope and spirit of the invention as defined in the appended claims.

As it is apparent from those embodiments, for example, one of the units to be coupled to the respective ends of the rotating shafts 2 and 22 within the coreless motor 1 by being disposed in the space section within the coreless motor, or specifically in the space section formed inside the inner yoke 5 in the radial direction thereof is implemented by the braking assembly, the rotary encoder assembly or the speed reduction assembly that includes the various gears.

The unit to be coupled to the end of the rotating shaft within the coreless motor by being disposed in the space section within the coreless motor is not restricted to those assemblies mentioned above but may be any of the other assemblies such as the torque sensor, the electric circuit and the like. Any unit that has its outer peripheral diameter smaller than the inner peripheral diameter of the inner yoke may be coupled to the end of the rotating shaft within the coreless motor by being disposed in the space section formed within the coreless motor.

It may be understood from the above description that the coreless motor offered by the present invention is provided for allowing the unit to be coupled to the end of the rotating shaft within the coreless motor by disposing it in the space section formed within the coreless motor and thus eliminates the need of increasing the length (size) in the direction in which the rotting shaft extends. Various types of the unit can thus be incorporated in the coreless motor by coupling them to the respective ends of the rotating shaft within the coreless motor.

### DESCRIPTION OF REFERENCE NUMERALS

The following is a list of the reference numerals referred to in the specification and accompanying drawings:
1 coreless motor
2 rotating shaft
3 stator
4 cylindrical coil
5 inner yoke
6 outer yoke
7 rotor
8 magnet
9 housing
10 tubular section
11a, 11b bearing assemblies
12 end of the rotating shaft in the coreless motor
12a forward end of the rotating shaft in the coreless motor
13 unit incorporated in the coreless motor
14a. space section in the coreless motor
15 another unit incorporated in the coreless motor
21a, 21b fixed shafts
22 rotating shaft
23 high speed side sun gear
24 high speed side planetary gear
25 high speed side carrier
27 low speed side sun gear
27a sun gears
28 low speed side planetary gears
28a planetary gear
29 low speed side carrier
29a carrier
30 coil
31 stator
32 outer yoke
33 inner yoke
34 rotor
35 magnet
36 housing

1. A coreless motor which comprises:
a cylindrical coil arranged concentrically with a central shaft acting as the center of rotation, the end surface on one side of said cylindrical coil being supported by a stator and extending in the direction in which the central shaft extends;
a rotor including a cylindrical inner yoke and a cylindrical outer yoke between which said cylindrical coil is sandwiched and between which a magnetic circuit is formed, said rotor being disposed concentrically with said central shaft and being supported by said central shaft on the central side thereof in the radial direction; and
a cylindrical housing including a cylindrical section provided outside said cylindrical outer yoke in the radial direction and being provided rotatably with respect to said central shaft, wherein the coreless motor allows a unit coupled to the end of said central shaft within the coreless motor to be disposed in a space formed within said coreless motor.

2. The coreless motor as defined in claim 1, wherein the side of said central shaft that faces opposite the end to which the units are to be coupled is supported rotatably in two locations spaced away from each other in the direction in which said central shaft extends and on the central side of said housing in the radial direction thereof, thereby allowing said housing to rotate with respect to the central side in the radial direction thereof.

3. A coreless motor which comprises:
a cylindrical coil arranged concentrically with a central shaft acting as the center of rotation, the end surface on one side of said cylindrical coil being supported by a stator and extending in the direction in which the central shaft extends;
a rotor including a cylindrical inner yoke and a cylindrical outer yoke between which said cylindrical coil is sandwiched and between which a magnetic circuit is formed, said rotor being disposed concentrically with said central shaft and being supported by said central shaft on the central side thereof in the radial direction; and
a cylindrical housing including a cylindrical section provided outside said cylindrical outer yoke in the radial direction and being provided rotatably with respect to said central shaft and having said cylindrical section that is driven for rotation by the rotation of said central shaft, wherein the coreless motor allows a unit coupled to the end of said central shaft within said coreless motor to be disposed formed within said coreless motor.

4. The coreless motor as defined in claim 3, wherein said unit is a mechanism that transmits the rotation of said central shaft to said housing.

5. The coreless motor as defined in claim 3, wherein the side of said central shaft that faces opposite the end to which said unit is to be coupled is supported rotatably in two locations spaced away from each other and on the central side of said stator in the radial direction thereof.

6. The coreless motor as defined in claim 1, wherein said space section is formed by allowing said central shaft not to extend through said cylindrical coil in the direction in which said central shaft extends and by thus terminating said central shaft on the middle way of said cylindrical coil in the direction in which said central shaft extends.

7. The coreless motor as defined in claim 1, wherein said space section is formed by allowing said central shaft not to extend through said cylindrical inner yoke in the direction in which said central shaft extends and by thus terminating said central shaft on the middle way of said inner yoke in the direction in which said central shaft extends.

8. The coreless motor as defined in claim 1, wherein said unit has its outer peripheral diameter that is smaller than the inter peripheral diameter of said inner yoke.

9. The coreless motor as defined in claim 1, wherein said unit has a portion on the side facing opposite the side on which said any one of said units is attached to the end of said central shaft and has its outer peripheral diameter that is larger than the inner peripheral diameter of said inner yoke.
